(19) United States
(12) Patent Application Publication
(10) Pub. No.: US 2019/0337175 A1
(43) Pub. Date: Nov. 7, 2019

(54) CUTTING DEVICE

(71) Applicant: PEI-KENG LIU, Yilan (TW)

(72) Inventor: PEI-KENG LIU, Yilan (TW)

(21) Appl. No.: 15/967,602

(22) Filed: May 1, 2018

(51) Int. Cl. B26B 25/00; B25G 1/10; B25G 3/38

(52) U.S. Cl. CPC B26B 25/005; B25G 3/38; B25G 1/102

(57) ABSTRACT

The invention provides a cutting device having a main body, a cutting component and a connection member. The cutting component is mutually assembled with the main body via the connection member, and the cutting component is further provided with a cutting member, wherein a blade portion and an extension portion of the cutting member form an angle of 60 to 84 degrees therebetween. Accordingly, a user is able to hold a holding portion thereof and press the blade portion of the cutting component against an object to be cut so as to perform cutting; the cutting component can be rotated 360 degrees via the connection member, such that the cutting component can be rotated to all angles when a cutting direction is changed, thereby achieving the effect of easily changing the cutting direction thereof.

### FIELD OF THE INVENTION

The present invention relates to a cutting device, and more particularly to a cutting device capable of facilitating holding and being rotated 360 degrees.

### BACKGROUND OF THE INVENTION

Conventionally, a handheld cutter used for cutting papers is usually a box cutter or a hobby knife. Although the box cutter and the hobby knife both have advantages like being light in weight, portable and having replaceable blades, they still have disadvantages in regard to design as follows: firstly, the blades of the box cutter and the hobby knife are usually directed at a single direction, and so cutting can only be performed in a single direction; whenever the direction of cutting needs to be changed or when cutting more complicated graphs, the whole arm of the user needs to move according to the cutting direction or the object to be cut needs to be adjusted in direction, and consequently causing inconvenience in actual use. Further, the blades of the box cutter and the hobby knife are usually in the shape of pieces. When the object to be cut is thick and hard to be cut, the blades are easily broken due to excessive force being applied, which could indirectly cause injury to the user. In addition, the cutting by the knives is performed by the user applying force from the handheld position towards the blade; after a long period of use, the user is susceptible to pains and discomfort in the front-end muscles of the index finger, the front-end and outer sides of the joint in the middle finger and the front-end muscles of the thumb resulted from the application of force. Therefore, it is imperative to find a solution to mitigate or improve the aforementioned problems.

The key to improve the above disadvantages and problems is also the technical difficulty the inventor of the present application seeks to resolve.

### SUMMARY OF THE INVENTION

To effectively solve the aforesaid problems, a primary object of the present invention is to provide a cutting device capable of facilitating holding and being rotated 360 degrees.

To achieve the aforesaid purpose, the invention provides a cutting device having a main body, a cutting component and a connection member, wherein the main body has a holding portion formed thereon, and the cutting component is mutually assembled with the main body via the connection member; the cutting component has an end thereof opposite to the connection member provided with a cutting member, and the cutting member has a blade portion and at least one extension portion, in which the extension portion is extended along a side of the blade portion and is integrally extended and connected thereto; the blade portion and the extension portion form an angle of 60 to 84 degrees therebetween. Accordingly, a user is able to hold the holding portion and press the blade portion of the cutting component against an object to be cut so as to perform cutting. Further, the cutting component can be rotated 360 degrees via the connection member, such that the cutting component can be rotated to all angles when a cutting direction is changed, thereby achieving the effect of easily changing the cutting direction thereof.

In addition, the cutting component can be joined with the connection member by using a bearing or a universal joint, so as to enable the cutting component to be easily rotated at 360 degrees and to all angles.

Further, the holding portion can be designed as being capable of having a configuration position thereof adjusted upwards and downwards along an axial direction of the main body. Accordingly, the user is enabled to further adjust an appropriate handheld position according to his/her own use habit, a gripping posture or an angle for cutting, so that the user can perform cutting more comfortably. The user can also constantly adjust the gripping posture and avoid working injuries to the hands caused by fixed postures and fixed positions for applying force after a long period of use. Furthermore, the holding portion can be made of different materials to enhance comfort.

Additionally, an inclined angle of less than 90 degrees can be designed between the cutting component and the main body, such that the blade portion of the cutting component is perpendicular or almost perpendicular to the object to be cut, thus enabling the force applied by the user to be maximally transferred to the object to be cut, thereby making cutting to be less laborious and more comfortable. The cutting member of the cutting component can be fixed or replaceable, so that when the cutting member is worn out from long periods of use or inappropriate uses, the cutting member can be easily replaced and thus extending the lifespan of the invention.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a stereoscopic perspective view in accordance with a preferred embodiment of the present invention.

FIG. 2 is a local perspective view I in accordance with a preferred embodiment of the present invention.

FIG. 3 is a local perspective view II in accordance with a preferred embodiment of the present invention.

FIG. 4 is a local perspective view III in accordance with a preferred embodiment of the present invention. FIG. 5 is an implemented perspective view I in accordance with a preferred embodiment of the present invention.

FIG. 6 is an implemented perspective view II of a preferred embodiment of the present invention.

FIG. 7 is an implemented perspective view III of a preferred embodiment of the present invention.

### DETAILED DESCRIPTION OF THE PREFERRED EMBODIMENTS

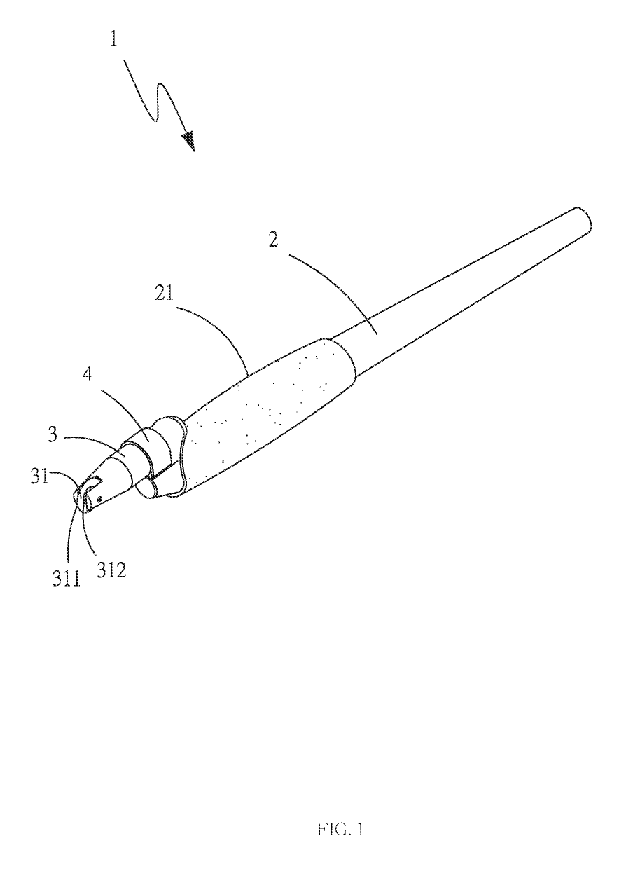

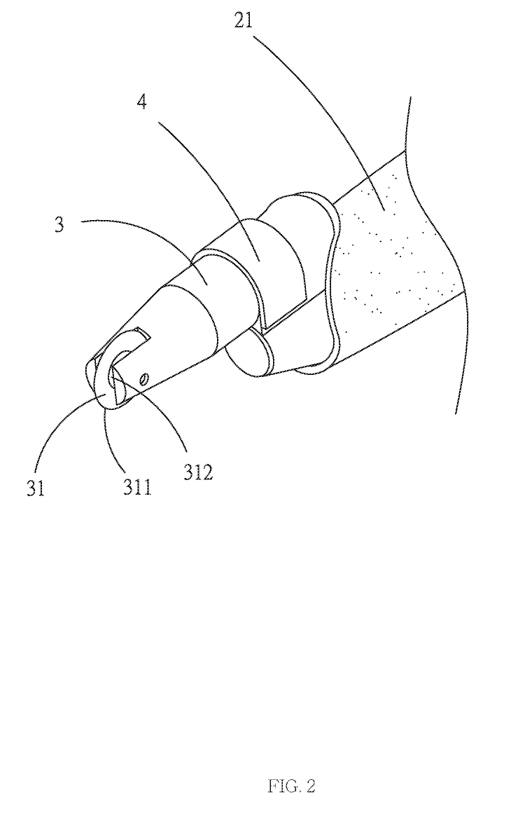

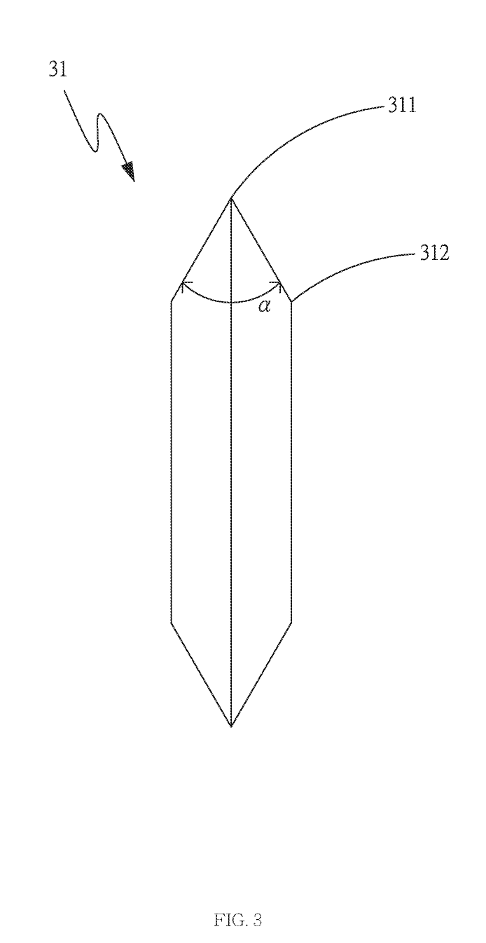

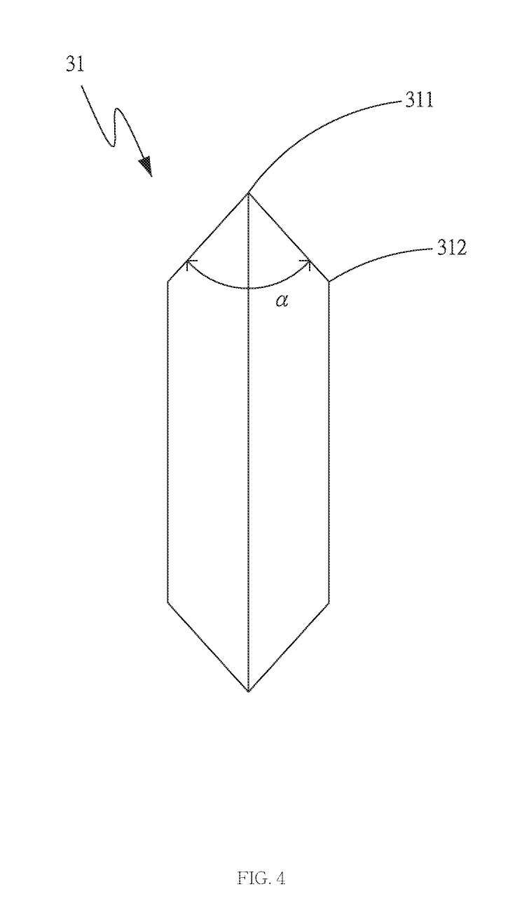

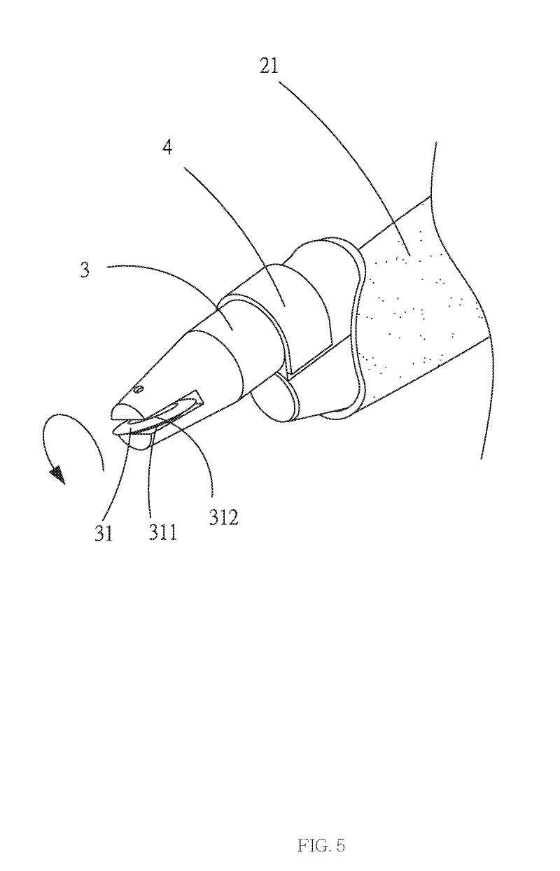

Referring to FIG. 1 to FIG. 4, a stereoscopic perspective view and local perspective views I to III show a preferred embodiment of the present invention. It can be clearly noted from the figures that the cutting device 1 comprises a main body 2, a cutting component 3 and a connection member 4, wherein the main body 2 has a holding portion 21 provided thereon, and the main body may be in a shape which is convenient to hold, such as a rod, a sphere, a column or rectangular. In this embodiment, the main body 2 is implemented in the shape of a pen, and the holding portion 21 is provided on a circumferential end of the main body 2. Further, the cutting component 3 is provided on an end of the main body 2 adjacent to the holding portion 21; a connection member 4 is provided between the cutting component 3 and the main body 2, and the connection member 4 can be made of a fiber reinforced plastic material or a metal material; the cutting component 3 is assembled with an end of the main body 2 via the connection member 4, and the cutting component 3 is joined with the connection member 4 by using a bearing or a universal joint. The holding portion 21, the connection member 4 and the cutting component 3 can be integrally formed, and the cutting component 3 has an end thereof opposite to the connection member 4 provided with a cutting member 31. The cutting member 31 includes a blade portion 311 and at least one extension portion 312, wherein the extension portion 312 is extended along a side of the blade portion 311 and is integrally extended and connected thereto, and an angle formed between the blade portion 311 and the extension portion 312 is between 60 to 84 degrees.

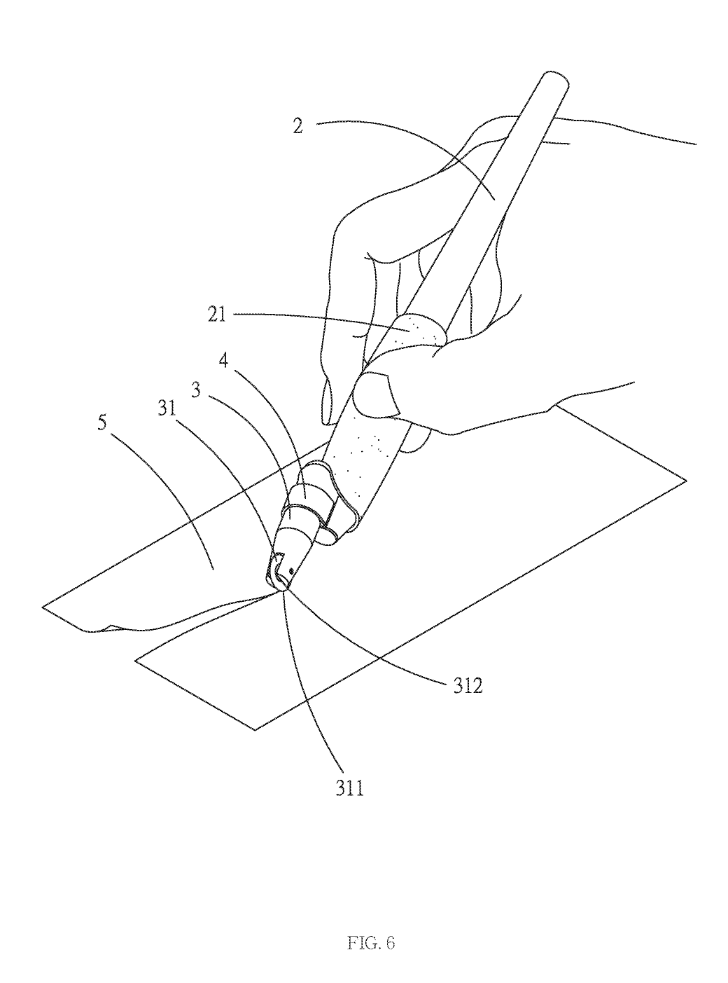

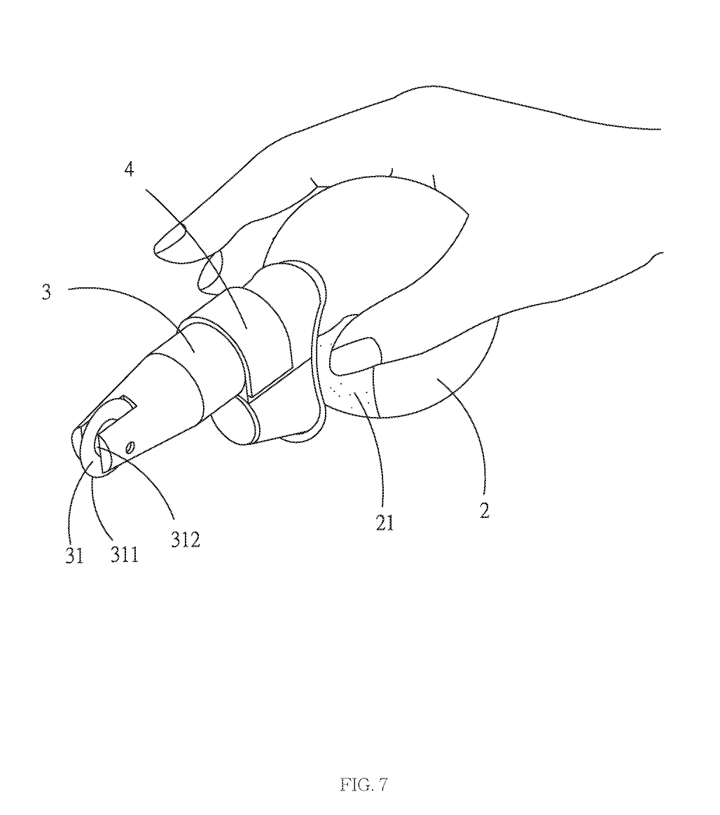

Referring to the aforementioned figures and FIG. 5 to FIG. 7, implemented perspective views I, II and III illustrate a preferred embodiment of the present invention. When a user uses the cutting device 1, the cutting component 3 can be rotated 360 degrees in parallel with the connection member 4, and a plane of rotation of the cutting component 3 is parallel with a plane of contact of the connection member 4. When a cutting direction is required to be changed, the cutting component 3 can be rotated to all angles so as to easily change the cutting direction thereof. Therefore, the issue of the conventional means in which cutting can only be performed in a single direction can be resolved, and thus the user is no longer required to move the whole arm to accommodate to the cutting direction or adjust the direction of an object to be cut 5 as a whole, and only needs to turn the direction of the cutting member 31 to change the cutting direction easily, thereby making the use of the cutting device more convenient. In addition, when the user is using the cutting device 1, the user is enabled to hold the device in a more comfortable posture which is closer to an angle of the normal pen-holding posture, such that an applied force can be maximally transferred to the cutting member 31. Moreover, the embodiment of the present invention joins the connection member 4 to the cutting component 3 by using a bearing or a universal joint so as to enable the cutting component 3 to be rotated 360 degrees and to all angles, thereby achieving the purpose of enabling the cutting member 31 of the present invention to be readily rotated to any direction of cutting. The embodiment further has an inclined angle designed therein, in which an inclined angle of less than 90 degrees is included between the cutting component 3 and an axial line of the main body 2. As mentioned previously in the present invention, in the general pen-holding posture, there is an inclined angle between a tip of the pen and a piece of paper being written on. In this embodiment, the inclined angle can assist the user in the normal pen-holding posture, such that the blade portion 311 of the cutting member 31 is perpendicular or almost perpendicular to the object to be cut 5, thus enabling a force applied by the user to be maximally transferred to the cutting member 31; an angle formed between the blade portion 311 and the extension portion 312 of the cutting member 31 is between 60 to 84 degrees, so as to enable the blade portion 311 to effectively and aligningly cut the object to be cut 5. The cutting member 31 can be a fixed or a replaceable cutting member 31; when the cutting member 31 is worn out from long periods of use or inappropriate uses, the cutting member 31 can be easily replaced and thus extending the lifespan of the invention. The material of the cutting member 31 can be a stainless steel, a high-carbon steel, an alloy or a diamond, and different materials can be selected for the cutting member 31 according to the hardness of a material required to be cut. Furthermore, in the embodiment of the present invention, the cutting member 31 is a roller cutter, and the design of the roller cutter can help avoid the disadvantage of only a single cutting direction is provided in the conventional means, and can also enable the user to have a smoother operation when the pen-like cutting device 1 of the present invention is used for cutting; when the cutting direction is changed, the changing of the direction is facilitated by using the cutting member 31. In addition, the holding portion 21 can be moved upwards and downwards along an axial direction of the main body 2, such that a most appropriate handheld position can be reached via adjustments according to a use habit of the user, and thus the user is enabled to perform cutting in a more comfortable manner. After a long period of use, the user can also constantly adjust a gripping position and avoid working injuries to the hands caused by fixed postures and continuous applications of force. Furthermore, the holding portion 21 can be made of different materials (such as silicone rubber, elastic foam or resin) to enhance comfort. Further, referring to FIG. 7, the main body 2 can also be a sphere, and the holding portion 21 is further provided on the sphere, such that the user can directly grip and hold the main body 2 and the holding portion 21. The sphere further has the connection member 4 and the cutting component 3 mounted on the connection member 4 provided thereon; via the main body 2, the user can have the blade portion 311 of the cutting member 31 to be perpendicular or almost perpendicular to the object to be cut 5, such that the force applied by the user can be maximally transferred to the cutting member 31, thereby achieving an effect of facilitating holding and cutting and 360-degree of rotation.

While the present invention has been disclosed through the preferred embodiment described above, it should be understood that the embodiment is not intended to be restrictive of the scope of the invention. Modifications may be made in accordance with the idea of the present invention without departing from the spirit and the scope of the present invention, such as: alterations to shapes or arrangement modes thereof, and any changes, modifications and applications equivalent in effect are comprised in the scope of the claims of the present application.

1. A cutting device, comprising:
a main body having a holding portion thereon;
a cutting component, having a tapered shape and comprising a cutting member having a blade portion and at least one extension portion extended along a side of the blade portion, an angle formed between two sidewalls of the blade portion is between 60 to 84 degrees; and
a connection member provided between the main body and the cutting component, wherein the cutting component is mutually assembled with the main body through the connection member;
wherein the main body is substantially parallel to and misaligned with the cutting component.

2. The cutting device of claim 1, wherein a plane of rotation of the cutting component is parallel with a plane of contact of the connection member so that the cutting component can be rotated 360 degrees on the main body via the connection member.

3. (canceled)

4. The cutting device of claim 1, wherein the main body can be in a shape of a rod, a sphere or a column.

5. (canceled)

6. The cutting device of claim 2, wherein the connection member can be a fiber reinforced plastic material or a metal material.

7. The cutting device of claim 2, wherein the holding portion, the connection member and the cutting component are integrally formed.
